(19) United States
(12) Patent Application Publication
(10) Pub. No.: US 2021/0085437 A1
(43) Pub. Date: Mar. 25, 2021

(54) STABLE WATER FLOSSER

(71) Applicant: One Chic Technology (Shaoxing) Co., Ltd, Shaoxing (CN)

(72) Inventors: Miaojun LI, Shaoxing (CN); Zhou LU, Shaoxing (CN)

(21) Appl. No.: 17/026,203

(22) Filed: Sep. 19, 2020

(30) Foreign Application Priority Data
Sep. 19, 2019 (CN) 201921561689.X

(51) Int. Cl. A61C 17/02; A61C 17/024

(52) U.S. Cl. CPC A61C 17/0217; A61C 17/024

(57) ABSTRACT

A stable water flosser includes a body and a head. A nozzle is provided at the head. A liquid and air storage chamber that is communicated to the nozzle is provided inside the head, and a diameter of the liquid and air storage chamber is larger than that of the nozzle. The water flosser has a compact structure and is capable of effectively avoiding the pressure reduction of the air and the liquid.

### CROSS-REFERENCE TO RELATED APPLICATIONS

This application claims the benefit of priority from Chinese Patent Application No. 201921561689.X, filed on Sep. 19, 2019. The content of the aforementioned application, including any intervening amendments thereto, is incorporated herein by reference in its entirety.

### TECHNICAL FIELD

The present application relates to oral care, and more particularly to a stable water flosser.

### BACKGROUND

Tooth brushing is widely adopted for personal oral care. Dental experts pointed out that brushing teeth is typically used for the cleaning of surfaces of teeth that are reachable by a toothbrush. However, both sides of the teeth, especially gingival crevice, should be cleaned by other dental care products. Water flossers are a novel oral cleaning device. However, the existing water flossers jet air and liquid at the same time through an air pump and an liquid pump, which causes the decrease of pressure after the air and the liquid flow through the air pipe and the liquid pipe. As a result, the actual jetting force of such water flosser is smaller than pre-set value, which will affect the cleaning effect.

### SUMMARY

In view of the problems in the prior art, the present disclosure provides a water flosser which has a compact structure and is capable of effectively avoiding the pressure reduction of the air and the liquid.

The present disclosure provides a stable water flosser, comprising:

a body; and

a head; wherein the head is provided with a nozzle; a chamber for storing air and liquids communicated to the nozzle is provided inside the head; and a diameter of the chamber is larger than that of the nozzle.

The working principles of the water flosser are described as follows. During the use, the air and the liquid pass through the head and accumulate in the chamber, and then to the nozzle. This causes the increase of the pressure of the air and the liquid in the nozzle since the diameter of the chamber is larger than that of the nozzle. The water flosser of the present disclosure is capable of effectively avoiding the pressure reduction of the air and the liquid when the air and the liquid flow from the head to the nozzle.

In some embodiments, the head is provided with a tip that is detachable; the nozzle is arranged in the tip; and the chamber is arranged at a connection between the head and the tip.

In some embodiments, a channel is provided between the chamber and the nozzle; one end of the channel is communicated to the chamber, and the other end of the channel is communicated to the nozzle; and a first seal ring and a mesh are provided at an inlet of the channel.

In some embodiments, a cross section of the channel is trapezoidal; an opening of a bottom of the channel is connected to the chamber; an axis of the channel is perpendicular to an axis of the nozzle, and the channel is communicated to the nozzle.

In some embodiments, the head is further provided with an air conduit and a liquid conduit.

In some embodiments, the body is provided with an upper cover, a lower cover, a reservoir, a liquid pump, a battery, an air pump and a control system, and a mounting hole is provided on the upper cover; the reservoir is provided with a reservoir cover; the battery is configured to supply power to the liquid pump, the air pump and the control system; the liquid pump is configured to supply liquid to the head, and the air pump are configured to supply air to the head; and the control system is configured to control on and off of the liquid pump and the air pump.

In some embodiments, a second seal ring is provided on the body for sealing of a connection of the head and the body.

In some embodiments, the liquid pump is communicated to the reservoir through a suction pipe, and the liquid pump is communicated to the head through a liquid inlet pipe.

In some embodiments, the air pump is communicated to the head through an air inlet pipe.

In some embodiments, a side of a bottom of the body is provided with a charging interface through which the battery is charged.

In some embodiments, the tip and the head are connected through threads. The water flosser of the present invention has a compact structure and high reliability, and is capable of effectively avoiding the pressure reduction of the air and the liquid.

### BRIEF DESCRIPTION OF THE DRAWINGS

FIG. 1 is a cross-sectional view of a stable water flosser in accordance with an embodiment of the present disclosure;

FIG. 2 is an enlarged view of a tip of the stable water flosser of FIG. 1 in accordance with an embodiment of the present disclosure; and

FIG. 3 shows an interior of the stable water flosser in accordance with an embodiment of the present disclosure.

In the drawings, 1, body; 2, head; 3, control switch; 4, mounting hole; 5, channel; 6, threads; 7-1, first seal ring; 7-2, second seal ring; 8, upper cover; 9, lower cover; 10, reservoir; 11, liquid pump; 12, battery; 13, air pump; 14, control system; 15, reservoir cover; 16, tip; 17, nozzle; 18, liquid and air storage chamber; 19, mesh; 20, air conduit; 21, liquid conduit; 22, suction pipe; 23, liquid inlet pipe; 24, air inlet pipe; 25, charging interface.

### DETAILED DESCRIPTION OF EMBODIMENTS

The present disclosure will be further described clearly and completely below with reference to the embodiments and the accompanying drawings. It should be understood that these embodiments are merely illustrative of the disclosure, and are not intended to limit the disclosure.

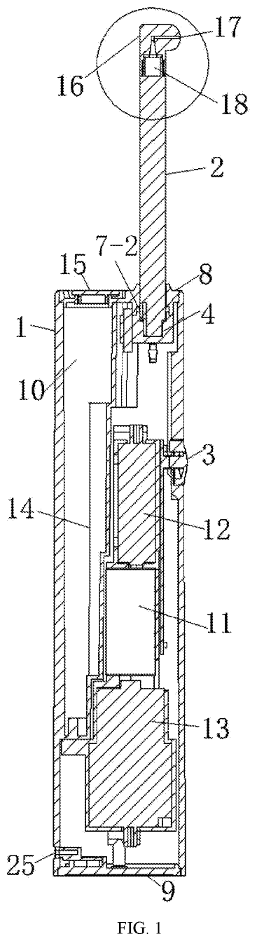

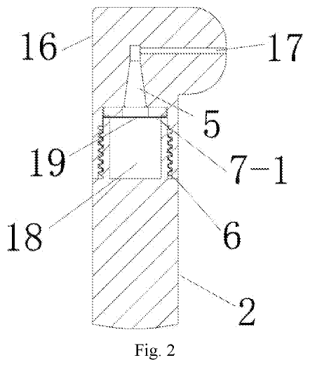

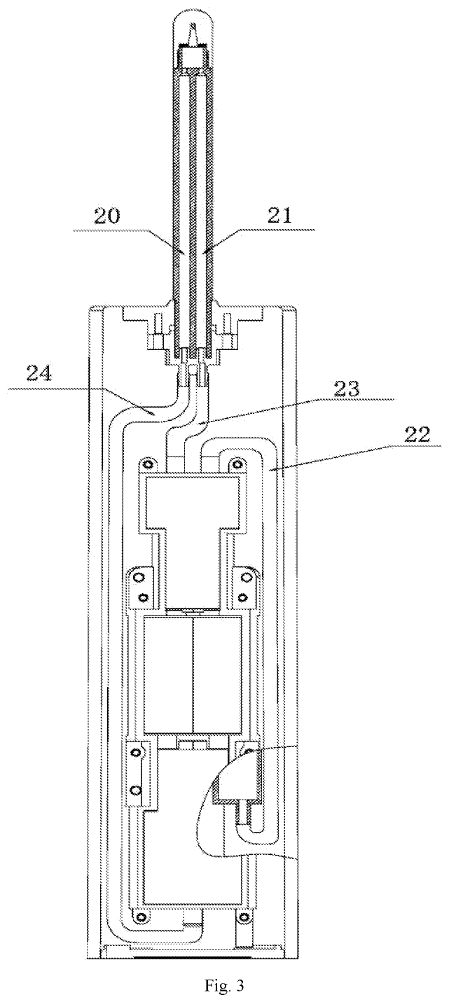

As shown in FIGS. 1-3, the stable water flosser includes a body 1 and a head 2. The head 2 is provided with a nozzle 17. A chamber 18 for storing air and liquids communicated to the nozzle 17 is provided inside the head 2, and a diameter of the chamber 18 is larger than that of the nozzle 17. The air and the liquids flow into and accumulate in the chamber 18, and then to the nozzle 17. This causes the increase of the pressure of the air and the liquids in the nozzle 17 since the diameter of the chamber 18 is larger than that of the nozzle 17.

In some embodiments, the head 2 is provided with a tip 16 that is detachable. The nozzle 17 is arranged on the tip 16, and the chamber 18 is arranged at a connection between the head 2 and the tip 16 for easy replacement of the tip 16.

In some embodiments, a channel 5 is arranged between the chamber 18 and the nozzle 17, where one end of the channel 5 is communicated to the chamber 18, and the other end of the channel 5 is communicated to the nozzle 17. A first seal ring 7-1 and a mesh 19 are provided at an inlet of the channel 5. The first seal ring 7-1 ensures the sealing of the connection of the tip 16 and the head 2 to prevent the pressure attenuation caused by leakage of liquid and air. The mesh 19 is configured for filtration.

In some embodiments, a cross section of the channel 5 is trapezoidal. An opening of a bottom of the channel 5 is communicated to the chamber 18. An axis of the channel 5 is perpendicular to an axis of the nozzle 17, and the channel 5 is communicated to the nozzle 17. By using such structure, the pressure of the liquid and air flow into the nozzle 17 can be further increased.

In some embodiments, the head 2 is further provided with an air conduit 20 and a liquid conduit 21.

In some embodiments, the body 1 is provided with an upper cover 8, a lower cover 9, a reservoir 10, a liquid pump 11, a battery 12, an air pump 13 and a control system 14. A mounting hole 4 is provided on the upper cover 8. The reservoir 10 is provided with a reservoir cover 15. The battery 12 is configured to supply power to the liquid pump 11, the air pump 13 and the control system 14. The liquid pump 11 and the air pump 13 are configured to supply liquid and air to the head 2, respectively. The control system 14 is configured to control on and off of the liquid pump 11 and the air pump 13. The liquid pump 11 and the air pump 13 are standard components that are common in the field, and will not be described herein. The arrangement of the upper cover 8, the lower cover 9 and the reservoir cover 15 can facilitate the disassembly of the body 1 and the filling of the reservoir 10. The battery 12 is preferably a rechargeable lithium battery 12, and the water flosser can work without any external power source.

In some embodiments, a second seal ring 7-2 is provided on the body 1 for sealing of a connection of the head 2 and the body 1, thereby avoiding the leakage of water and electricity.

In some embodiments, the liquid pump 11 is communicated to the reservoir 10 through a suction pipe 22, and is communicated to the head 2 through a liquid inlet pipe 23. The liquid inlet pipe 23 is connected to the liquid conduit 21.

In some embodiments, the air pump 13 is communicated to the head 2 through an air inlet pipe 24.

In some embodiments, a side of a bottom of the body 1 is provided with a charging interface 25 through which the battery 12 is charged.

In some embodiments, the tip 16 and the head 2 are connected through threads 6.

The above are only the preferred embodiments of the present disclosure, and are not intended to limit the scope of the present disclosure. Any changes, equivalent modifications and improvements based on the concept of the present disclosure, shall fall within the protection scope of the present disclosure.

What is claimed is:

1. A stable water flosser, comprising:
a body; and
a head;
wherein the head is provided with a nozzle; a chamber for storing air and liquids is provided in the head and is communicated to the nozzle; and a diameter of the chamber is larger than that of the nozzle.

2. The stable water flosser of claim 1, wherein the head is provided with a tip that is detachable; the nozzle is arranged in the tip; and the chamber is arranged at a connection between the head and the tip.

3. The stable water flosser of claim 1, wherein a channel is provided between the chamber and the nozzle; one end of the channel is communicated to the chamber, and the end of the channel is communicated to the nozzle; and a first seal ring and a mesh are provided at an inlet of the channel.

4. The stable water flosser of claim 2, wherein a channel is provided between the chamber and the nozzle; one end of the channel is communicated to the chamber, and the other end of the channel is communicated to the nozzle; and a first seal ring and a mesh are provided at an inlet of the channel.

5. The stable water flosser of claim 3, wherein a cross section of the channel is trapezoidal; an opening of a bottom of the channel is connected to the chamber; an axis of the channel is perpendicular to an axis of the nozzle, and the channel is communicated to the nozzle.

6. The stable water flosser of claim 4, wherein a cross section of the channel is trapezoidal; an opening of a bottom of the channel is connected to the chamber; an axis of the channel is perpendicular to an axis of the nozzle, and the channel is communicated to the nozzle.

7. The stable water flosser of claim 1, wherein the head is further provided with an air conduit and a liquid conduit.

8. The stable water flosser of claim 1, wherein the body is provided with an upper cover, a lower cover, a reservoir, a liquid pump, a battery, an air pump and a control system;
a mounting hole is provided on the upper cover; the reservoir is provided with a reservoir cover; the battery is configured to supply power to the liquid pump, the air pump and the control system; the liquid pump is configured to supply liquid to the head, and the air pump are configured to supply air to the head; and the control system is configured to control on and off of the liquid pump and the air pump.

9. The stable water flosser of claim 1, wherein a second seal ring is provided on the body for sealing of a connection of the head and the body.

10. The stable water flosser of claim 6, wherein the liquid pump is communicated to the reservoir through a suction pipe, and the liquid pump is communicated to the head through a liquid inlet pipe; and the air pump is communicated to the head through an air inlet pipe.

11. The stable water flosser of claim 6, wherein a side of a bottom of the body is provided with a charging interface through which the battery is charged.

12. The stable water flosser of claim 2, wherein the tip and the head are connected through threads.
